(19) United States
(12) Patent Application Publication
(10) Pub. No.: US 2014/0379516 A1
(43) Pub. Date: Dec. 25, 2014

(54) CONTEXT BASED RECOMMENDER SYSTEM

(71) Applicant: THOMSON LICENSING, Issy de Moulineaux (FR)

(72) Inventors: Asher LEVI, Haifa (IL); Osnat MOKRIN, Haifa (IL); Christophe DIOT, Paris (FR); Nina TAFT, San Francisco, CA (US)

(21) Appl. No.: 13/922,037

(22) Filed: Jun. 19, 2013

(51) Int. Cl. G06Q 30/06

(52) U.S. Cl. CPC G06Q 30/0631
USPC 705/26.7

(57) ABSTRACT

A method and system for a context based search recommendations is provided. A context based search can be facilitated for the construction of cold start recommender systems. Contextual information can be mined from review texts from sources such as websites, and analyzed for common traits per context group. From this context information the most applicable reviews for the user can be provided. One embodiment provides a method for providing recommendations. The method includes the steps of preprocessing one or more reviews based on features of the one or more reviews, obtaining context information about user; and determining score for user based on obtained user context information and features of the one or more reviews.

### REFERENCE TO RELATED APPLICATIONS

This application claims the benefit of U.S. Provisional Application Ser. No. 61/663,382 filed Jun. 22, 2012 which is incorporated by reference herein in its entirety.

### TECHNICAL FIELD

This invention relates to recommendation systems, and more particularly to a method and apparatus for providing cold start context based recommendations.

### BACKGROUND ART

Online searching for things like hotels and restaurants is a daunting task due to the wealth of online information. Reviews written by others replace the word-of-mouth, yet turn the search into a time consuming task. Often users do not rate enough establishments to enable a collaborative filtering based recommendation.

A lot of research has already been performed in the area of recommender systems and information retrieval. However, most recommender systems focus on recommending the most relevant items to users without taking into account any additional contextual information. Most existing information retrieval systems based their retrieval decisions solely on queries collections, whereas information about search context is often ignored.

Thus, a method and system that can make “cold start” recommendations based on context of the search rather is needed.

### BRIEF SUMMARY

This disclosure describes a method for providing context based search recommendations. Herein it is set forth that context based search can be facilitated for the construction of cold start recommender systems. Contextual information can be mined from review texts, and analyzed for common traits per context group. From such contextual information the most applicable reviews for the user can be provided.

One embodiment of the disclosure provides a method for providing recommendations. The method includes the steps of preprocessing one or more reviews based on features of the one or more reviews, obtaining context information about user; and determining score for user based on obtained user context information and features of the one or more reviews.

Another embodiment of the disclosure provides an apparatus for providing recommendations. The apparatus includes storage, memory and a processor. The storage and memory are for storing data. The processor is configured to preprocess reviews based on features of reviews, obtain context information about user, and determine a score for user based on obtained user context information and features of the one or more reviews.

For exemplary purposes the description of the embodiments will focus on hotel recommendations for a user. However, it should be understood that the cold start recommendations techniques and methodologies described herein could be applied to and type of cold start recommendations.

Objects and advantages will be realized and attained by means of the elements and couplings particularly pointed out in the claims. It is important to note that the embodiments disclosed are only examples of the many advantageous uses of the innovative teachings herein. It is to be understood that both the foregoing general description and the following detailed description are exemplary and explanatory and are not restrictive of the invention, as claimed. Moreover, some statements may apply to some inventive features but not to others. In general, unless otherwise indicated, singular elements may be in plural and vice versa with no loss of generality. In the drawings, like numerals refer to like parts through several views.

### BRIEF SUMMARY OF THE DRAWINGS

FIG. 1 depicts a block schematic diagram of a cold start recommender system according to an embodiment.

FIG. 2 depicts a block schematic diagram of a server according to an embodiment.

FIG. 3 depicts a block schematic diagram of a methodology for providing cold start recommendations according to an embodiment.

FIG. 4 depicts exemplary features associated with aspects according to an embodiment.

### DETAILED DESCRIPTION

Turning now to FIG. 1, a block diagram of an embodiment of a system 100 for implementing a context based cold start recommender system is provided. The system uses a database for storing information associated with recommendations and user contexts. As such, the system includes a server 110 and one or more electronic devices such as: smart phones 120; personal computers (PCs) 130, such as desktops or laptops; and tablets 140 in communication with the server 110 over the internet. Servers 160a, 160b providing review websites are also accessible via the internet 150. The server 110 provides the processing and storage for the context based cold start recommender system where a database can also be run from the server 110. Users interface with the context based cold start recommender system on the server 110 using a browser or application on the electronic devices such as smartphones 120, PCs 130, or tablets 140.

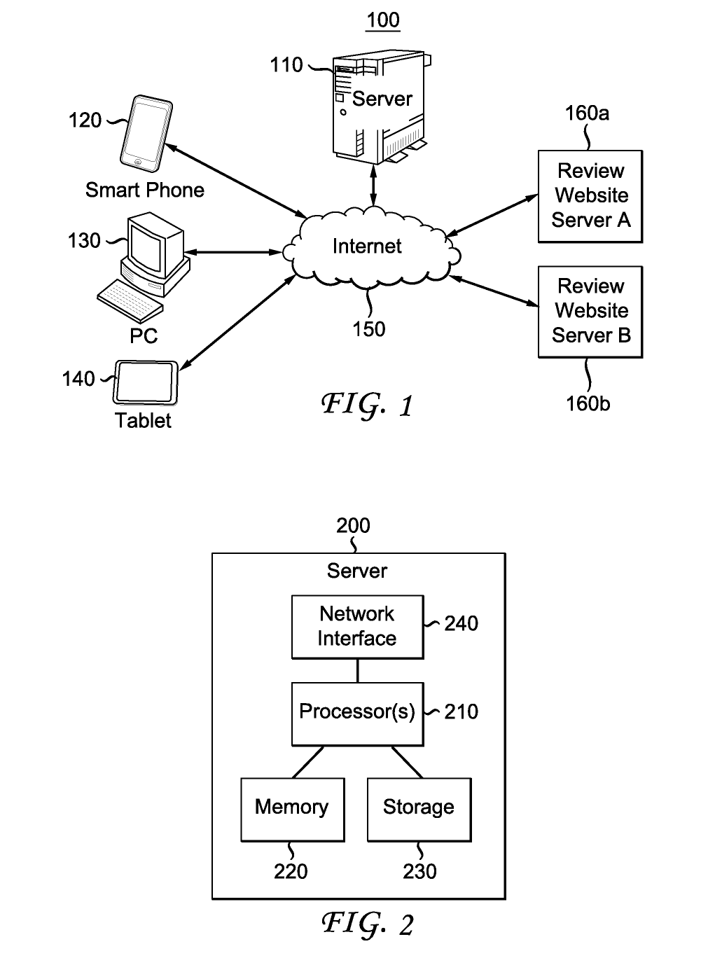

FIG. 2 depicts an exemplary server 200 that can be used to implement the methodology and system for cold start recommendations. The server includes one or more processors 210, memory 220, storage 230, and a network interface 240. Each of these elements will be discussed in more detail below.

The processor 210 controls the operation of the electronic server 200. The processor 200 runs the software that operates the server as well as provides the functionality of cold start recommendations. The processor 210 is connected to memory 220, storage 230, and network interface 240, and handles the transfer and processing of information between these elements. The processor 210 can be general processor or a processor dedicated for a specific functionality. In certain embodiments there can be multiple processors.

The memory 220 is where the instructions and data to be executed by the processor are stored. The memory 220 can include volatile memory (RAM), non-volatile memory (EEPROM), or other suitable media.

The storage 230 is where the data used and produced the processor in executing the cold storage recommendation methodology of the present is stored. The storage may be magnetic media (hard drive), optical media (CD/DVD-Rom), or flash based storage.

The network interface 240 handles the communication of the server 200 with other devices over a network. Examples of suitable networks include Ethernet networks, Wi-Fi enabled networks, and the like. Other types of suitable home networks will be apparent to one skilled in the art given the benefit of this disclosure.

It should be understood that the elements set forth in FIG. 2 are illustrative. The server 200 can include any number of elements and certain elements can provide part or all of the functionality of other elements. Other possible implementation will be apparent to on skilled in the art given the benefit of this disclosure.

### System Overview

A recommender system typically won't have sufficient historical information to build profiles for individuals. Such systems do, however, have additional data in the form of reviews that is sufficient to enable the characterization of context groups. Here an overview of the method and system, which determines common traits for groups that share the same context is given. The core idea of the method and system is to give more importance to reviews of people with the same context. The method and system brings greater importance to the topics those reviewers focus on frequently and also focuses on topics that are associated with the user's stated preferences. For example, in the hotel arena people can be categorized by their trip intent (such as those who travel as a ‘couple’, or a ‘family’, etc.) and nationality, which are referred to herein as context groups. Using the text reviews posted on websites from multiple people within a single context group, it is possible to essentially find the common traits of groups such as ‘family’ travelers (and so on for the other categories). Additionally, processing the corpus of reviews is used to identify the vocabulary that to describe a particular aspect of a hotel. Once a user using the disclosed method and system specifies their intent, nationality and preferences, the system evaluates reviews with accordance with the traits and preferences, and gives a recommendation.

Users' search pattern is context based. Among the plethora of reviews, readers opt for recommendations from users with comparable needs. In the example of hotel recommendations, a single traveler may share the same needs as other single travelers. A user traveling with her family has different needs from a user traveling on a business trip, i.e. the user context information is an important factor in choosing a hotel. When a user reads reviews, the user can metaphorically be seen as wearing personalized glasses. Reviews are read through those glasses, and particular words or comments will resonate, positively or negatively, with the reader based upon their needs for their upcoming trip and their personal preferences. Special attention is often given to reviews written with the same intent, or by reviewers from a comparable background. Hence, three types of context information are defined.

The first type of context is intent. For the hotel recommendation example, this would be the purpose of the trip. For the hotel recommendation example, there are 5 categories of intent, namely: business trip, single traveler on vacation, family, group, couple.

The second type of context is nationality such as American, Italian, French, Chinese, and the like.

The third context is user preferences for the different hotel aspects. These are mined from the text using an unsupervised clustering algorithm. For the hotel recommendation example, the tagged different clusters found in the text are: location, service, food, room, price-value quality, and the facilities (pool, spa, etc), and the like.

Thus, a user using the disclosed system or method is asked to provide her trip intent, nationality, and preferences for these aspects.

Review data can be obtained from review websites to create a database which can be implemented on server 110. For the hotel recommendation example, these could include Venere.com and TripAdvisor.com. The database contains details for each hotel: the hotel's general information, reviews and ratings. For a pre-processing phase, the text of the websites are mined and common traits are found for each context group. These are found in the form of typical words that appear more in text written within that context but are not common for other contexts. A clustering is used to group words that refer to each aspect.

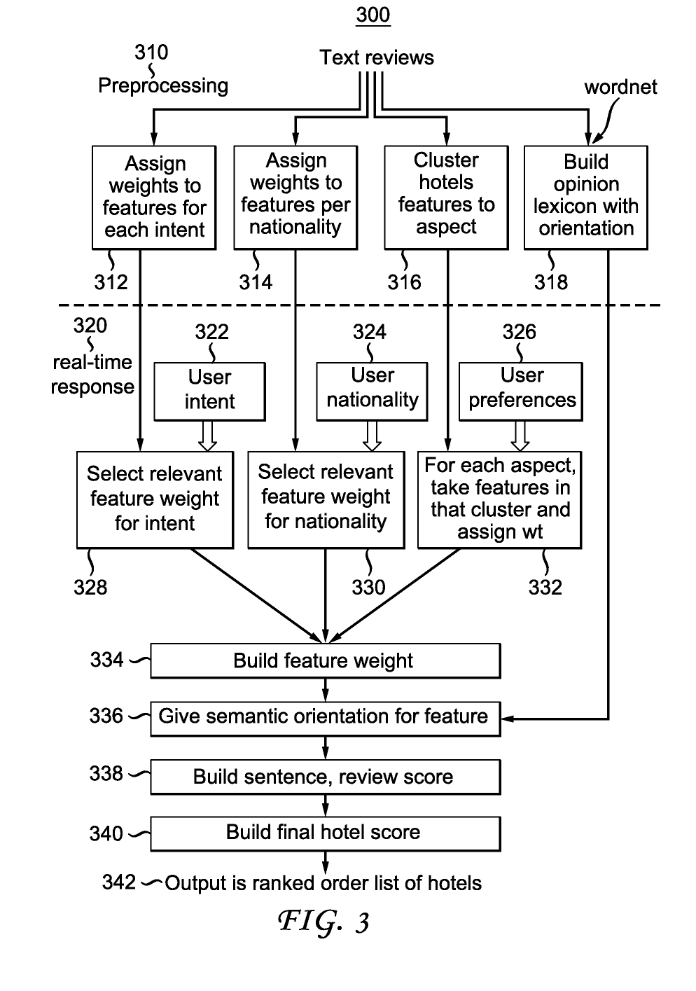

The components and steps of the method can be seen in the block diagram 300 of FIG. 3. The top 3 boxes (312, 314, and 316) on the left correspond to the pre-processing phase 310 in which the system defines the common traits of intent 312 and nationality groups 314, and defines the different hotel aspects referenced in reviews 316, correspondingly. To find common traits for each context group, nouns and noun phrases (called features) are extracted from all reviews to find those that are more common for a particular group. These features are then assigned a weight per each context according to their relative frequency in reviews within that context. The higher the weight, the more important a feature. The common traits of context groups are the higher weight features for that group. Hence, the common traits of Italians (as a nationality) consist of a set of features and their weights, while these of Germans may contain largely the same features but with different weights.

Common traits of hotel aspects are constructed differently. A clustering task is performed to cluster features based upon co-occurrence in the same sentence. Each feature can only occur in one cluster, and thus each cluster contains the most relevant vocabulary for that aspect.

The fourth component 318 of the preprocessing phase 310 comprises of building an opinion lexicon which allows for the analysis of adjectives associated with features, and to give each feature an orientation score depending upon how positive or negative is the sentiment of any associated adjectives.

Thus, at the end of this pre-processing phase 310, there are significant words per context, be it intent, nationality, or hotel aspect.

In the real time response phase 320, the user is prompted for her trip intent, nationality and preferences per hotel aspect. A weighted algorithm for context based text mining is then used for each context (blocks 328, 330, and 332). The core idea of the algorithm is to give more importance to reviews of people with the same contexts as the users. Common traits per the user's context groups and words that describe favorable hotel aspects are given a higher score than other words. The sentiment expressed in the review per context (i.e., positive or negative) is determined (block 336) and a corresponding score is given (block 340). Thus, the final score for each review corresponds to that a user with comparable needs and preferences coming from a similar background would give.

While the base weight of each feature is one in the exemplary system, features that are distinctive of several context groups may have different weight per group. The specific set of weights used in response to a user search will be chosen once the user declares their context and preferences. For example, in the case of hotel recommendations, if a user specifies ‘business traveler’ as her intent and her nationality, then the set of feature weights used will be those in the ‘business traveler’ group and the corresponding national group. In FIG. 3, this process corresponds to the “select relevant feature weight for intent” box 328 and “select relevant feature weight for nationality” box 330. Similarly, corresponding weights are given to features of important aspects corresponding to box 322. This implies, for example, that the feature ‘air conditioning’ will get one weight depending upon its importance for business travelers, a second weight depending upon its importance for the given nationality, and a third weight depending upon its importance per the user preference for the aspect it belongs to.

The final weight for each feature is done by combining these three weights (depicted as “build feature score” box 334 in the FIG. 3). Next the opinion lexicon 318 is used to give each feature an orientation score as represented by box 336. The features, their weights and orientations are combined to build a score for each sentence as represented as represented by box 338. The sentence scores are then combined to give an overall score for each review as represented by box 340. This score should reflect the relative importance of the given review for the user. Reviews that are both important and positive are deemed most relevant thereby receiving the highest scores. The final score for each hotel is an average of all of its reviews, each of which is scored from the user's perspective (i.e., based on their context and preferences), and an adjustment bias calculated per the context given. A ranked order list of hotels is then generated for output (342). Each of these steps is discussed in more detail below.

### Context Based Analysis

The main idea of the method for context based text analysis is to assign weights to common traits per context. Thus, at the end of the process, each review is mapped to a score number, based on the system's perception of the user's perspective.

### Intent and Nationality Profiling

Common traits for each context group are found by mining the text from reviews on a sentence level. One such approach is to extract key features (i.e., words) that are important for each group. It has been shown that a reviewer's vocabulary when commenting on an item was found to converge, in the sense that the most frequently used nouns and noun phrases used correspond to genuine and important features. Features are extracted and redundant and meaningless items removed from the candidate features found.

The basic building block of methodology is a trait based weight assigning. For each review written the features are extracted and assigned a weight that reflects its importance for each context group. Let c denote a general context that can be either an intent (or purpose) p or a nationality n. (i.e., c∈{p}∪{n}), and let freq_{f}(c) denote the frequency of feature f for context c. The frequency of a feature per context is the relative number of occurrences of feature f in sentences appearing in reviews that belong to context c. For example, the frequency of the feature ‘WiFi’ for Americans (as a nationality context) is calculated as the ratio of the number of times this feature appeared in sentences written by Americans, divided by the total number of sentences written by Americans. Similarly, avg_{f} is the average frequency of feature f, stdv_{f} is its standard deviation, and dev_{f}=avg_{f}−stdv_{f}. Using this notation, the weight of a feature f for a given context is defined as follows:

$${W}_{c}^{f} = \{ \begin{matrix}1 , & if \vert {dev}_{f} \vert < {stdv}_{f} \\ Max ( 0.1 , 1 - \frac{{dev}_{f}}{{stdv}_{f}} ) , & if \frac{{dev}_{f}}{{stdv}_{f}} < - 1 \\ 1 + \frac{{dev}_{f}}{{stdv}_{f}} , & else\end{matrix} \qquad ( 1 )$$

The majority of features will either be assigned a 1; however those whose frequency is larger than average plus or minus one standard deviation, are assigned values between 1 and 3 or 0.1 and 1 respectively. Hence each feature is assigned a weight in the range [0:1; 3] per context.

### Aspect Profiling

Recall that the user was asked to input their preferences on six aspects. These aspects were not selected at random, but were instead the result of a word clustering analysis performed on the text. Often in reviews, different words may be used to refer to the same general aspect of a hotel. For example, words like ‘area’, ‘street’, and ‘metro’ may all refer to aspects of a hotel's location. There are many approaches to clustering, hierarchical clustering, partition clustering (e.g. k-means as known in the art) etc. The number of clusters, k, is usually either an input parameter or found by the clustering procedure itself. In the present case, clustering would yield the different hotel aspects and therefore should not be supervised but determined by the clustering algorithm over the text itself. To account for the sparsity and the overlapping characteristics in the network of word features, an unsupervised cluster detection technique is build upon. A network graph is built in which each node corresponds to a feature and each cluster will correspond to a hotel aspect. Trying to find the maximal modularity is defined as finding a partition that will minimize the energy of the features network graph. The Hamiltonian, denoted in equation 2 is defined in the following way: existing internal edges and non-existing external links (between formed clusters) minimize the Hamiltonian, while existing external links and non-existing internal links increase its value. The algorithm tries to find a partition that minimizes the Hamiltonian, based on the spin glass model for finding a partition that minimizes the energy of the spin glass with the spin states being correlated to the cluster indices.

$$H ( \{ σ \} ) = - {\sum }_{i \neq j}^{ } {a}_{ij} \underbrace{{A}_{ij} δ ( {σ}_{i} , {σ}_{j} )}_{internal links} + {\sum }_{i \neq j}^{ } {b}_{ij} \underbrace{( 1 - {A}_{ij} ) δ ( {σ}_{i} , {σ}_{j} )}_{internal non - links} + {\sum }_{i \neq j}^{ } {a}_{ij} \underbrace{{A}_{ij} ( 1 - δ ( {σ}_{i} , {σ}_{j} )}_{external links} - {\sum }_{i \neq j}^{ } {b}_{ij} \underbrace{( 1 - {A}_{ij} ) δ ( {σ}_{i} , {σ}_{j} )}_{external non - links} \qquad ( 2 )$$

Where Aᵢⱼ is a Boolean adjacency matrix, σᵢ∈1; 2; : : : q denotes the indices of the communities, with q the number of maximal communities. The spin glass model shows that the division does not depend on q, for large initial q values.

In the spin model aᵢⱼ and bᵢⱼ where chosen as a function of the probability of two graph nodes to be adjacent under the assumption that when this probability is high the nodes are more likely to belong to same group, or community. In the present case, this translates to the probability of two features to appear in a sentence together. However, it was found in reviews that very frequent features are often found in sentences together. For example, it is common to find sentences of the following structure:

The location was great and the room was very clean.

Clearly, location and room belong to different hotel aspects, and should therefore belong to different communities. To account for this tendency, the PMI-Pointwise mutual information weight was used, which measures the information overlapping between two random variables, described in equation 3.

$${PMI}_{ij} = log ( \frac{p ( i ⋀ j )}{p ( i ) \cdot p ( j )} ) \qquad ( 3 )$$

Where, p(i) is the probability that the feature i appears in a sentence. Then, aᵢⱼ=γ·PMIᵢⱼ, where γ is a parameter expressing the relative contribution to the energy from existing and missing edges. In this case γ=1 was chosen.

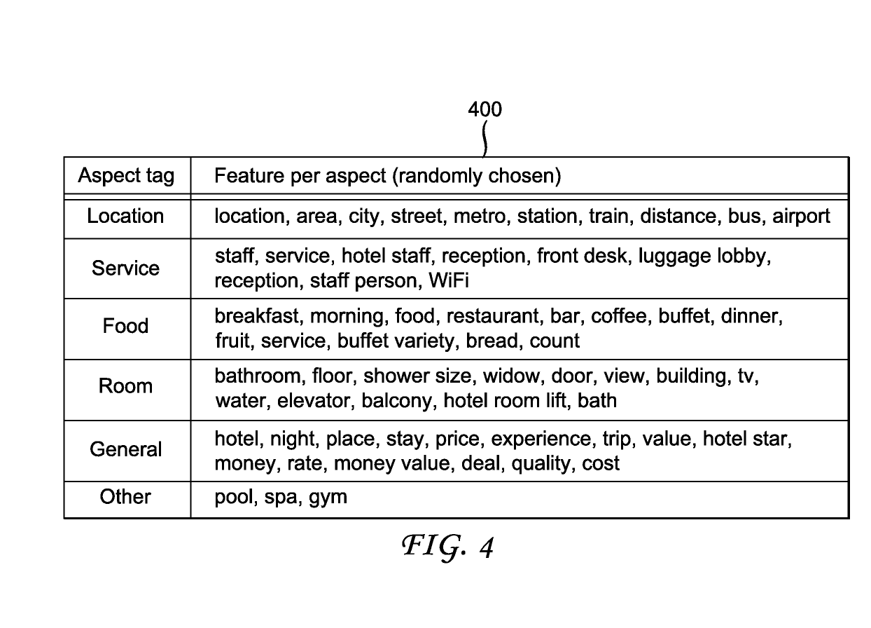

Over the corpus of reviews, the PMI-pointwise improvement of the spinning glass community detection algorithm produced six clusters of different sizes (note that the number of clusters is unsupervised). The identification of these 6 clusters is important as it determined the particular hotel aspects that were chosen to ask users their preferences for. Each cluster and the set of features it contains can be thought of, intuitively, as the common traits for the aspect associated with this cluster. These clusters are useful as follows. Suppose for example that a user specifies that location is of utmost importance to them. The room cluster identifies a large number of features (or words) that are often used to discuss things inside a hotel room; thus reviews in which these words occur frequently are more important to a user who cares about the room than one who cares about food. After studying the words that ended up in each cluster, the cluster names were selected as indicated in the Table shown in FIG. 4. These clusters can be computed ahead of time as part of the system's preprocessing.

The weight assigning algorithm for aspect related features relates to the user's preference and is calculated online as follows: Let u_{pref}(k) denote user u's preference for aspect (i.e. cluster) k. If feature f is in cluster k, then the weight for the feature according to the user's preferences is calculated as follows in equation 4:

$${W}_{{u}_{pref} ( k )}^{f} = 1 + \frac{{u}_{pref} ( k )}{5} \qquad ( 4 )$$

Where, Wᵤ_{_{pref}}₍ₖ₎^{f} denotes the weight of feature f for user u according to her preference u_{pref}(k). For example, if the user sets their preference for location to 5, and the feature is train, then the weight of train for this user is 2. Another user that specifies that location is of importance 1, would have the feature train assigned a weight of 1.2. When determining the weight for the feature train only the user's preference for location (and not for room or food) is used because the feature ‘train’ is in the location cluster and cannot be in any other cluster.

### Feature Opinion Orientation

Next the polarity of the opinion expressed in the review on each feature is determined, whether positive or negative, to assign a corresponding sign to a feature's weight. To infer the opinion polarity per feature an opinion lexicon is used. An opinion lexicon is a dictionary of words and word phrases that express positive or negative sentiments. In this example, sentiment words are considered to be adjectives the reviewers use to express opinions on product features. To collect the opinion word list a corpus-based approach is used. All the adjectives that appear in the same sentence are extracted for each feature.

The semantic orientation of the extracted opinion words is then found. When the reviewer uses a word that expresses a desirable state, then the word is classified as having a positive semantic orientation. Similarly, an undesirable state translates to a negative semantic orientation. A bootstrapping lexicon-based approach is used. Manually, a set of seed adjectives is created from the opinion lexicon list with semantic orientation. Then for each adjective in the seed list, a synonym and an antonym is searched for in WordNet. Each found adjective in the opinion lexicon is assigned an orientation, and is added to the seed list. The seed list grows in the process.

Common opinion rules are used as known in the art. One is the negation rule, words or phrases like ‘no’, ‘not’, etc. take the opposite orientation expressed by the opinion phrase. The other is the ‘but’ clause rules, a sentence containing ‘but’ also needs special treatment. The opinions before and after a ‘but’ are usually opposite of each other. First an attempt is made in the method to determine the semantic orientation of the feature in the ‘but’ clause. If the orientation of the phrase cannot be determined the opposite orientation of the clause before the ‘but’ clause is taken. Phrases such as ‘with the exception of’, ‘except for’ etc. behave similarly to ‘but’ and are handled in the same way. For example, in the sentence “The room was clean except for the bathroom”, the opinion about the feature room is positive and the feature bathroom gets the inverse opinion which is negative. There are also some phrases that contain negation and but words, yet do not change the orientation of the opinion. For example in the phrase “I do not only like the size of the room, but also its style”, the ‘not’, ‘but’ words do not change the orientation of the opinion words ‘like’ and ‘style’.

Using these rules and our lexicon, an orientation score is assigned to each feature fin a given sentence s, denoted score(f,s). It should be clear that the same feature, in two different sentences, could receive different orientations. When many opinion words surround a single feature, they are aggregated as indicated in equation 5.

$$score ( f , s ) = {\sum }_{op ∈ s}^{ } \frac{{or}_{op}}{d ( op , f )} \qquad ( 5 )$$

Here op is an opinion word in sentence s, d(op,f) is the distance (word count) between feature f and opinion word op in sentence s. Also, orₒₚ is the orientation (−1, +1) of the opinion word op.

Dividing by the distance between the feature and the opinion word is used to give lower weights to opinion words that are farther away from f. When the final score is positive, then the overall opinion of feature fin s is positive, and similarly the reviewer's opinion of the feature is negative when the final feature score is negative.

### Producing a Review Score

A set of weights and their orientation per the user's context for each feature in a review are obtained. These elements are combined to produce a single score for a review as follows. Given the user's input on their context, each feature has 3 weights, one for intent, Wᵤ_{ₚ}^{f}, one for nationality, Wᵤ_{ₙ}^{f}, and one based on aspect preferences Wᵤ_{_{pref}}^{f}. The final weight Wᵤ^{f} assigned to feature f for user u is the multiplication of these three weights, namely as shown in equation 6:

Wᵤ^{f}=Wᵤ_{ₚ}^{f}·Wᵤ_{ₙ}^{f}·Wᵤ_{pref}^{f} (6)

The weights for each context are multiplied because that allows fine grained differentiation of people within our various groups (such as intent and nationality). Consider a Japanese person who uses our system. Based upon our nationality profiling, it can be seen that the feature ‘bath’ is important. If that person also marks ‘Room’ as a hotel aspect that is very important to them (i.e. a preference of 5), then the quality of the bathroom is more important for this user than for a second Japanese person who marks ‘room’ as low priority and ‘food’ as high priority. This allows us to differentiate within nationalities by using the intent and preferences (or to differentiate within an intent group by their nationality and preferences).

To produce a score for each sentence, each feature is multiplied by its orientation score and the weight scores of all features in a sentence s is summed up, namely Σ_{f∈s}Wᵤ^{f}·score(f, s). Similarly, the scores of all the sentences in a review is summed to produce a score for a review v, as follows:

$$score ( υ , u ) = {\sum }_{s ∈ υ}^{ } {\sum }_{f ∈ s}^{ } {W}_{u}^{f} \cdot score ( f , s ) \qquad ( 7 )$$

Where score(v; u) is the score of review v for user u. The review score captures how important a particular review is for the user based upon their context and preferences.

### Devising a Hotel Score

Next a score for each hotel is produced so that hotels can be ranked and presented to the user in order from highest score to lowest. The major factor in the score of a hotel in our system is the score calculated for reviews based on user context groups and preferences. This the hotel orientation score is termed, hoᵤ, where hoᵤ=avg_{v∈R}_{₍ₕ₎}[score(v, u)] and R₍ₕ₎ denotes the set of reviews for hotel h. The second argument is a bias adjustment, denoted bₕₛₙ, which captures the bias of a user with intent p and nationality n, as well as any hotel bias h. (The bias term is explained below.)

Thus our final hotel score is given by equation 8:

Sᵤ^{h}=hoᵤ+bₕₚₙ (8)

Bias Adjustment to Hotel Score: In the hotel score, the orientation score coming from the text analysis of the reviews is the dominant component of the score, as these values will range from −40 to 80 approximately. The bias terms range from 0 to 5 and are included primarily to break ties, or to differentiate hotels when their scores are very close. The process of using the star ratings needs to be adjusted for bias because there are systematic tendencies for some traveler groups to rate higher than others. For example, data analysis shows that reviewers from Spain tend to rate lower in star rating systems than reviewers from the USA.

The bias bₕₚₙ for hotel h from traveler with both intent p and nationality n is computed as follows as shown in equation 9. Let μ denote the overall average star rating of all hotels in the system. The parameter bₕ specifies the observed deviations of hotel h from the overall average. The parameter bₕₚ is used to denote the observed deviations that travelers with intent p have for hotel h, (and similarly for bₕₙ). These deviations are with respect to the average score of hotel h.

bₕₚₙ=μ+bₕ+bₕₚ+bₕₙ (9)

The average deviations (as shown in equation 10) are shrunk towards zero by using the normalization parameters, λ₁; λ₂; λ₃, which are determined by validation on the test set. For each hotel h it is set:

$${b}_{h} = \frac{{\sum }_{{r}_{h} ∈ {R}_{( h )}}^{ } ( {r}_{h} - μ )}{{λ}_{1} + \vert {R}_{( h )} \vert} \qquad ( 10 )$$

where R₍ₕ₎ is a set of reviews for hotel h, and λ₁=30. The bias of intent group p for hotel h is:

$${b}_{hp} = \frac{{\sum }_{{r}_{hp} ∈ {R}_{( hp )}}^{ } ( {r}_{hp} - μ - {b}_{h} )}{{λ}_{2} + \vert {R}_{( hp )} \vert} \qquad ( 11 )$$

where R₍ₕₚ₎ is a set of reviews for p and h, and where λ₂=5. The bias of a nationality n for hotel h is given by:

$${b}_{hn} = \frac{{\sum }_{{r}_{hn} ∈ {R}_{( hn )}}^{ } ( {r}_{hn} - μ - {b}_{h} )}{{λ}_{3} + \vert {R}_{( hn )} \vert} \qquad ( 12 )$$

where, R₍ₕₙ₎ is the set of reviews from nationality n for h, and λ₃=5.

The various embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the embodiments and the concepts contributed by the inventor to furthering the art, and are to be construed as being without limitation to such specifically recited examples and conditions. Moreover, all statements herein reciting principles, aspects, and varies embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A method for providing recommendations, the method comprising:
preprocessing one or more reviews based on features of the one or more reviews;
obtaining context information about user; and
determining a score for the user based on obtained user context information and features of the one or more reviews.

2. The method of claim 1 wherein context information comprises: intent, nationality, and preferences.

3. The method of claim 2 wherein the context of intent is selected from the group comprising the categories of: business, single traveler, family, group, and couple.

4. The method of claim 2 wherein the preferences comprise aspect comprising: location, service, food, room, price-value quality, and facilities.

5. The method of claim 1 wherein the step of preprocessing one or more reviews based on features further comprises:
assigning weight to features for each category of intent;
assigning weight to features for each nationality;
clustering features to aspects of preferences; and
building an opinion lexicon.

6. The method of claim 1 further comprising the step of obtaining on or more reviews from one or more review websites.

7. The method of claim 1 wherein the step of determining review score for user based on obtained user context information further comprises:
determining weight for features based on obtained user context information;
determining orientation score for features;
determining review score for user; and
determining final score for user.

8. The method of claim 1 further comprising the step of generating a ranked order list of recommendations for user.

9. An apparatus for providing recommendations, the apparatus comprising:
a storage for storing review information;
a memory for storing data for processing;
a processor configured to preprocess one or more reviews based on features of the one or more reviews, obtain context information about user, and determine a score for user based on obtained user context information and features of the one or more reviews.

10. The apparatus of claim 9 further comprising a network connection for connecting to a network.

11. The apparatus of claim 9 wherein context information comprises: intent, nationality, and preferences.

12. The apparatus of claim 9 wherein the step of preprocessing one or more reviews based on features further comprises:
assigning weight to features for each category of intent;
assigning weight to features for each nationality;
clustering features to aspects of preferences; and
building an opinion lexicon.

13. The apparatus of claim 9 wherein the step of determining review score for user based on obtained user context information further comprises:
determining weight for features based on obtained user context information;
determining orientation score for features;
determining review score for user; and
determining final score for user.

15. A machine readable medium containing instructions that when executed perform the steps comprising:
preprocessing one or more reviews based on features of the one or more reviews;
obtaining context information about user; and
determining score for user based on obtained user context information and features of the one or more reviews.
